(19) United States
(12) Patent Application Publication
(10) Pub. No.: US 2017/0367379 A1
(43) Pub. Date: Dec. 28, 2017

(54) SMOOTH, SHELF-STABLE PRODUCT AND METHODS OF PRODUCING SAME

(71) Applicant: Nestec S.A., Vevey (CH)

(72) Inventor: Eric Edward GRAF, Holton, MI (US)

(21) Appl. No.: 15/540,650

(22) PCT Filed: Jan. 5, 2016
(86) PCT No.: PCT/IB2016/050041

§ 371 Date: Jun. 29, 2017

Related U.S. Application Data
(60) Provisional application No. 62/099,705, filed on Jan. 5, 2015.

(51) Int. Cl. A23L 3/16; A23C 9/154; A23L 19/00; A23L 29/206; A23L 33/00; A23L 13/40; A23C 3/03

(52) U.S. Cl. CPC A23L 3/16; A23L 13/40; A23C 9/154; A23C 3/03; A23L 29/206; A23L 33/40; A23L 19/09; A23V 2002/00

(57) ABSTRACT

A smooth, shelf-stable aseptically thermally processed food product, as well as methods of making same using a shear sensitive thickener, are disclosed.

### BACKGROUND

Many types of refrigerated products are currently on the market. By using refrigeration, food products can avoid spoiling for extended periods of time. However, food products that require refrigeration are more costly to store than non-refrigerated foods due to the energy costs associated with keeping the food products cold and/or the logistics involved in transporting the food products at a lower temperature.

Shelf-stable foods are foods that would normally need to be stored using refrigeration systems but have been processed so that they can be safely stored at room/ambient temperature and maintain a long shelf life. Various techniques exist to process foods so that they are shelf-stable—one of which is aseptically thermally processing the food product using heat. However, such a method has been found to result in unsatisfactory (i.e., unappetizing) textural features for certain food products, e.g., yogurt and pudding, due to the proteins therein denaturing and coagulating during aseptic thermal processing. As such, there is a need for a method to produce a food product that minimizes and/or counteracts the effect(s) of the denatured, coagulated proteins on the textural features (e.g., smoothness) of aseptically thermally processed food products so as to produce a shelf-stable food product that is appealing to a consumer and does not need refrigeration.

### DETAILED DESCRIPTION

Before explaining at least one embodiment of the presently disclosed and/or claimed inventive concept(s) in detail, it is to be understood that the presently disclosed and/or claimed inventive concept(s) is not limited in its application to the details of construction and the arrangement of the components or steps or methodologies set forth in the following description or illustrated in the drawings. The presently disclosed and/or claimed inventive concept(s) is capable of other embodiments or of being practiced or carried out in various ways. Also, it is to be understood that the phraseology and terminology employed herein is for the purpose of description and should not be regarded as limiting.

Unless otherwise defined herein, technical terms used in connection with the presently disclosed and/or claimed inventive concept(s) shall have the meanings that are commonly understood by those of ordinary skill in the art. Further, unless otherwise required by context, singular terms shall include pluralities and plural terms shall include the singular.

All patents, published patent applications, and non-patent publications mentioned in the specification are indicative of the level of skill of those skilled in the art to which this presently disclosed and/or claimed inventive concept(s) pertains. All patents, published patent applications, and non-patent publications referenced in any portion of this application are herein expressly incorporated by reference in their entirety to the same extent as if each individual patent or publication was specifically and individually indicated to be incorporated by reference.

All of the articles and/or methods disclosed herein can be made and executed without undue experimentation in light of the present disclosure. While the articles and methods of the presently disclosed and/or claimed inventive concept(s) have been described in terms of preferred embodiments, it will be apparent to those of skill in the art that variations may be applied to the articles and/or methods and in the steps or in the sequence of steps of the method described herein without departing from the concept, spirit, and scope of the presently disclosed and/or claimed inventive concept(s). All such similar substitutes and modifications apparent to those skilled in the art are deemed to be within the spirit, scope, and concept of the presently disclosed and/or claimed inventive concept(s).

As utilized in accordance with the present disclosure, the following terms, unless otherwise indicated, shall be understood to have the following meanings:

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or that the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects. For example, but not by way of limitation, when the term “about” is utilized, the designated value may vary by plus or minus twelve percent, or eleven percent, or ten percent, or nine percent, or eight percent, or seven percent, or six percent, or five percent, or four percent, or three percent, or two percent, or one percent. The use of the term “at least one” will be understood to include one as well as any quantity more than one, including but not limited to, 2, 3, 4, 5, 10, 15, 20, 30, 40, 50, 100, etc. The term “at least one” may extend up to 100 or 1000 or more, depending on the term to which it is attached; in addition, the quantities of 100/1000 are not to be considered limiting, as higher limits may also produce satisfactory results. In addition, the use of the term “at least one of X, Y, and Z” will be understood to include X alone, Y alone, and Z alone, as well as any combination of X, Y, and Z. The use of ordinal number terminology (i.e., “first,” “second,” “third,” “fourth,” etc.) is solely for the purpose of differentiating between two or more items and is not meant to imply any sequence or order or importance to one item over another or any order of addition, for example.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more items or terms, such as BB, AAA, AAB, BBC, AAABCCCC, CBBAAA, CABABB, and so forth. The skilled artisan will understand that typically there is no limit on the number of items or terms in any combination, unless otherwise apparent from the context.

As used herein, the term “substantially” means that the subsequently described event or circumstance completely occurs or that the subsequently described event or circumstance occurs to a great extent or degree. For example, when associated with a particular event or circumstance, the term “substantially” means that the subsequently described event or circumstance occurs at least 80% of the time, or at least 85% of the time, or at least 90% of the time, or at least 95% of the time. The term “substantially adjacent” may mean that two items are 100% adjacent to one another, or that the two items are within close proximity to one another but not 100% adjacent to one another, or that a portion of one of the two items is not 100% adjacent to the other item but is within close proximity to the other item.

The term “associate” as used herein will be understood to refer to the direct or indirect connection of two or more items.

The term “shelf-stable” as used herein refers to the ability of a food product to be safely stored and sold in a sealed container at room temperature while still having a useful shelf life in which the taste and nutritional aspects (i.e., nutritional integrity, nutritional potency, etc.) of the product is retained. Examples of periods considered to be a “useful shelf life” include, but are not limited to, at least about two months, at least about three months, at least about four months, at least about five months, at least about six months, and longer.

The phrase “food product” as used herein refers to the combination of at least one shear sensitive thickener and at least one food component like, for example but without limitation, a dairy product, a meat product, and/or a vegetable product. The phrase “food product” may also include any additives in addition to the combination of the at least one shear sensitive thickener and the at least one food component.

As used herein, the phrase “high in protein content” and variations of such refers to a food product and/or food component having a protein content of 2 wt % or greater of the food product and/or food component. Additionally, as used herein, “highly fortified food products,” “highly fortified dairy products,” “highly fortified food components,” and variations thereof refers to food products and/or food components that have been fortified with at least one of a vitamin and a mineral such that the vitamin and/or mineral comprises more than 5% daily value equivalent of one or more vitamins and/or minerals, or such that the vitamin(s) and/or mineral(s) comprises more than a 10% daily value equivalent of one or more vitamins and/or minerals.

Turning now to the presently disclosed and/or claimed inventive concept(s), certain embodiments thereof are directed to a method of producing a smooth, shelf-stable aseptically processed food product that addresses texture defects in food products in the prior art caused by protein denaturation and coagulation during aseptic thermal processing. Certain other embodiments of the presently disclosed and/or claimed inventive concept(s) are directed to a smooth, shelf-stable aseptically thermally processed food product, for example but without limitation, a smooth, shelf-stable aseptically thermally processed dairy product, and packages thereof for retail. Yet other embodiments of the presently disclosed and/or claimed inventive concept(s) are directed to a smooth, shelf-stable aseptically thermally processed food product that is high in protein and/or high in fortification with vitamin(s) and/or mineral(s).

In one embodiment, the presently disclosed and/or claimed inventive concept(s) is directed to a method of producing a smooth, shelf-stable food product in which a mixture comprising at least one food component and at least one shear sensitive thickener is aseptically homogenized. The food product comprising the mixture of the at least one food component and the at least one shear sensitive thickener may be an aseptically thermally processed food product.

The food component may be selected from the group consisting of dairy products, meat products, vegetable products, and combinations thereof. In one embodiment, the food component is a dairy product. The dairy product may be selected from the group consisting of pudding, yogurt, sour cream, buttermilk, and combinations thereof. In another embodiment, the at least one food component is selected from the group consisting of a meat puree, a vegetable puree, and combinations thereof. In one embodiment, the food component may be a baby food, wherein the baby food may be any of the above-described food components.

In one embodiment, the food component has a “high protein content,” wherein the protein content is about 2 wt % or greater of the food component and/or the food product. Food components with a high protein content are susceptible to protein denaturing and/or coagulating during aseptic thermal processing, which causes textural defects to the resulting thermally processed food component. It has been found, as disclosed and/or claimed herein, that the use of a shear sensitive thickener during aseptic homogenization creates a food product that is smoother than high protein-containing food components that have been aseptically thermally processed without such a shear sensitive thickener present during aseptic homogenization.

Additionally, in one embodiment, the food component may be fortified with at least one vitamin and/or mineral. The fortified food component may be fortified such that the food component comprises more than 5% daily value equivalent of the at least one vitamin and/or mineral, and/or more than 10% daily value equivalent of the at least one vitamin and/or mineral. The vitamin may include, for example but without limitation, Vitamins A, B-complex (such as B-1, B-2, B-6, and B-12), C, D, E, and K, niacin, acid vitamins such as pantothenic acid and folic acid, and biotin. The mineral may include, for example but without limitation, calcium, iron, zinc, magnesium, iodine, copper, phosphorus, manganese, potassium, chromium, molybdenum, selenium, nickel, tin, silicon, vanadium, and/or boron.

In one embodiment, the shear sensitive thickener includes citrus fiber. The disclosed and/or claimed inventive concept(s) have determined that shear sensitive thickeners like citrus fiber thicken under shear, for example but without limitation, aseptic homogenization, and provide a smoother food product by countering the textural defects caused by protein coagulation during aseptic thermal processing of food components.

The food product, as described in any of the embodiments above and including the shear sensitive thickener and food component, may further comprise one or more additives including, for example but without limitation, sweeteners, flavors, colors, acids, acidity regulators, anticaking agents, antifoaming agents, antioxidants, bulking agents, color retention agents, emulsifiers, flavor enhancers, flour treatment agents, glazing agents, humectants, preservatives, stabilizers, thickeners, and/or combinations thereof.

Any amounts of the shear sensitive thickener and food component may be combined together, so long as the smooth, shelf-stable food product can be formed therefrom. For example, but not by way of limitation, the shear sensitive thickener may be present at about 0.001 wt %, about 0.002 wt %, about 0.003 wt %, about 0.004 wt %, about 0.005 wt %, about 0.006 wt %, about 0.007 wt %, about 0.008 wt %, about 0.009 wt %, about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 2 wt %, about 3 wt %, about 4 wt %, about 5 wt %, about 6 wt %, about 7 wt %, about 8 wt %, about 9 wt %, about 10 wt %, about 11 wt %, about 12 wt %, about 13 wt %, about 14 wt %, about 15 wt %, about 16 wt %, about 17 wt %, about 18 wt %, about 19 wt %, about 20 wt %, about 21 wt %, about 22 wt %, about 23 wt %, about 24 wt %, about 25 wt %, about 26 wt %, about 27 wt %, about 28 wt %, about 29 wt %, about 30 wt %, about 31 wt %, about 32 wt %, about 33 wt %, about 34 wt %, about 35 wt %, about 36 wt %, about 37 wt %, about 38 wt %, about 39 wt %, about 40 wt %, about 41 wt %, about 42 wt %, about 43 wt %, about 44 wt %, about 45 wt %, about 46 wt %, about 47 wt %, about 48 wt %, about 49 wt %, about 50 wt %, about 55 wt %, about 60 wt %, about 65 wt %, about 70 wt %, about 75 wt %, and the like. In addition, particular embodiments of the presently disclosed and/or claimed inventive concept(s) include wt % values in a range formed by the combination of any of the above values.

In addition, the food component may be present in an amount of, for example but not by way of limitation, about 10 wt %, about 11 wt %, about 12 wt %, about 13 wt %, about 14 wt %, about 15 wt %, about 16 wt %, about 17 wt %, about 18 wt %, about 19 wt %, about 20 wt %, about 21 wt %, about 22 wt %, about 23 wt %, about 24 wt %, about 25 wt %, about 26 wt %, about 27 wt %, about 28 wt %, about 29 wt %, about 30 wt %, about 31 wt %, about 32 wt %, about 33 wt %, about 34 wt %, about 35 wt %, about 36 wt %, about 37 wt %, about 38 wt %, about 39 wt %, about 40 wt %, about 41 wt %, about 42 wt %, about 43 wt %, about 44 wt %, about 45 wt %, about 46 wt %, about 47 wt %, about 48 wt %, about 49 wt %, about 50 wt %, about 51 wt %, about 52 wt %, about 53 wt %, about 54 wt %, about 55 wt %, about 56 wt %, about 57 wt %, about 58 wt %, about 59 wt %, about 60 wt %, about 61 wt %, about 62 wt %, about 63 wt %, about 64 wt %, about 65 wt %, about 66 wt %, about 67 wt %, about 68 wt %, about 69 wt %, about 70 wt %, about 71 wt %, about 72 wt %, about 73 wt %, about 74 wt %, about 75 wt %, about 76 wt %, about 77 wt %, about 78 wt %, about 79 wt %, about 80 wt %, about 81 wt %, about 82 wt %, about 83 wt %, about 84 wt %, about 85 wt %, about 86 wt %, about 87 wt %, about 88 wt %, about 89 wt %, about 90 wt %, about 91 wt %, about 92 wt %, about 93 wt %, about 94 wt %, about 95 wt %, about 96 wt %, about 97 wt %, about 98 wt %, about 99 wt %, and the like. In addition, particular embodiments of the presently disclosed and/or claimed inventive concept(s) include wt % values in a range formed by the combination of any of the above values.

In addition, any wt % ratio of shear sensitive thickener to food component may be utilized in accordance with the presently disclosed and/or claimed inventive concept(s), so long as the smooth, shelf-stable food product can be formed therefrom. Non-limiting examples of wt % ratios of shear sensitive thickener to food component include about 0.001:1, about 0.002:1, about 0.003:1, about 0.004:1, about 0.005:1, about 0.006:1, about 0.007:1, about 0.008:1, about 0.009:1, about 0.01:1, about 0.015:1, about 0.02:1, about 0.025:1, about 0.03:1, about 0.035:1, about 0.04:1, about 0.045:1, about 0.05:1, about 0.055:1, about 0.06:1, about 0.065:1, about 0.07:1, about 0.075:1, about 0.08:1, about 0.085:1, about 0.09:1, about 0.095:1, about 0.1:1, about 0.15:1, about 0.2:1, about 0.25:1, about 0.3:1, about 0.35:1, about 0.4:1, about 0.45:1, about 0.5:1, about 0.55:1, about 0.6:1, about 0.65:1, about 0.7:1, about 0.75:1, about 0.8:1, about 0.85:1, about 0.9:1, about 0.95:1, about 1:1, about 2:1, about 3:1, about 4:1, about 5:1, about 6:1, about 7:1, about 8:1, about 9:1, about 10:1, and the like. In addition, particular embodiments of the presently disclosed and/or claimed inventive concept(s) include wt % ratios in a range formed by the combination of any of the above values.

The step of aseptically homogenizing the mixture comprising the at least one food component and the at least one shear sensitive thickener can be carried out using any homogenization technique as would be known in the field for homogenizing the food components as described herein. Various homogenization techniques are well known in the art, and thus no further description thereof is deemed necessary.

In one embodiment, the method of producing a smooth, shelf-stable food product further comprises aseptically thermally processing the mixture comprising at least one of the above-described food components and at least one shear sensitive thickener. The step of aseptically thermally processing the mixture comprises heating the mixture; the mixture may be heated to any temperature at which aseptic thermal processing of the mixture occurs. For example, but not by way of limitation, the mixture may be heated to a temperature of about 175° F., about 180° F., about 185° F., about 190° F., about 195° F., about 200° F., about 205° F., about 210° F., about 215° F., about 220° F., about 225° F., about 230° F., about 235° F., about 240° F., about 245° F., about 250° F., about 255° F., about 260° F., about 265° F., about 270° F., about 275° F., about 280° F., about 285° F., about 290° F., about 295° F., about 300° F., about 305° F., about 310° F., about 315° F., about 320° F., about 325° F., and the like. In addition, particular embodiments of the presently disclosed and/or claimed inventive concept(s) include heating the mixture to a temperature in a range formed by the combination of any of the above temperature values. Non-limiting examples of ranges include a range of from about 175° F. to about 325° F., a range of from about 175° F. to about 250° F., a range of from about 200° F. to about 230° F., a range of from about 200° F. to about 290° F., a range of from about 250° F. to about 325° F., and a range of from about 270° F. to about 290° F.

The method of heating the mixture during the aseptic thermal processing may use at least one of a direct heating method and/or an indirect heating method. The direct heating method may be, for example but without limitation, steam injection, steam infusion, and/or any other method of direct heating as would be known in the field. The indirect heating method may use, for example but without limitation, a plate heat exchanger, a tubular heat exchanger, a scraped surface heat exchanger, and/or any other method or mechanism of indirect heating as would be known in the field. In one embodiment, the food product is aseptically thermally processed by ultrahigh temperature processing. These various heating methods are well known in the art, and thus no further description thereof is deemed necessary.

In one embodiment, the mixture of the at least one food component and the at least one shear sensitive thickener has a pH greater than 4.6, which can be classified as a “low acid” food product. Low acid food products may be aseptically thermally processed by heating the mixture of the at least one food component and the at least one shear sensitive thickener at a temperature in a range of from about 250° F. to about 325° F., or from about 270° F. to about 290° F.

In another embodiment, the mixture of the at least one food component and the at least one shear sensitive thickener has a pH in a range of from about 2.5 to 4.6, which can be classified as an “acid” food product. Acid food products may be aseptically thermally processed by heating the mixture of the at least one food component and the at least one shear sensitive thickener at a temperature in a range of from about 175° F. to about 250° F., or from about 200° F. to about 230° F.

In one embodiment, the method of producing a smooth, shelf-stable food product, as described in any of the above-recited embodiments, may further include the step of at least partially cooling the mixture comprising at least one of the above-described food components and the at least one shear sensitive thickener after the step of aseptically thermally processing the mixture and prior to the step of aseptically homogenizing the mixture. The step of at least partially cooling the mixture may include at least partially cooling the mixture to a temperature such that the fats in the at least one food component are still in liquid form. The mixture may be partially cooled to any temperature that allows the food product subsequently produced to have the characteristics as described herein. For example, but not by way of limitation, the mixture may be partially cooled to a temperature of about 120° F., about 125° F., about 130° F., about 135° F., about 140° F., about 145° F., about 150° F., about 155° F., about 160° F., and the like. In addition, particular embodiments of the presently disclosed and/or claimed inventive concept(s) include partially cooling the mixture to a temperature in a range formed by the combination of any of the above temperature values, such as but not limited to, a range of from about 120° F. to about 160° F.

The method of at least partially cooling the mixture comprising the at least one food component and the at least one shear sensitive thickener uses at least one of a direct cooling method and/or an indirect cooling method. The direct cooling method may use, for example but without limitation, a flash or vacuum chamber and/or any other method or mechanism for cooling the mixture as would be known in the field. The indirect cooling method may use, for example but without limitation, a heat exchanger and/or any other method or mechanism for cooling the mixture as would be known in the field. Various types of cooling methods are well known in the art, and thus no further description thereof is deemed necessary.

In one embodiment, the method of producing a smooth, shelf-stable food product, as described in any of the above-recited embodiments, may further comprise a step wherein the at least one food component is heated prior to being mixed with the at least one shear sensitive thickener to form the mixture. The at least one food component may be mixed with the at least one shear sensitive thickener by any method as would be known in the field.

In one embodiment, the method of producing a smooth, shelf-stable food product, as described in any of the above-recited embodiments, may further comprise a step wherein the food product (i.e., the mixture of the at least one food component and the at least one shear sensitive thickener) is packaged into one or more packages after the step of aseptically homogenizing the mixture comprising the at least one food component and the at least one shear sensitive thickener. The method of packaging the food product may be any method as would be known in the field. Various types of packaging methods are well known in the art, and thus no further description thereof is deemed necessary.

The presently disclosed and/or claimed inventive concept(s) is also directed to a method of producing a smooth, shelf-stable food product. In the method, a mixture comprising at least one food component (as described above) and at least one shear sensitive thickener (as described above) are aseptically thermally processed, and the thermally processed mixture is aseptically homogenized.

The presently disclosed and/or claimed inventive concept(s) is also directed to a method of producing a smooth, shelf-stable food product, in which a mixture comprising at least one food component (as described above) and at least one shear sensitive thickener (as described above) is aseptically thermally processed, at least partially cooled, and then aseptically homogenized.

The presently disclosed and/or claimed inventive concept(s) is also directed to a method of producing a smooth, shelf-stable food product, in which at least one food component and at least one shear sensitive thickener are mixed to form a mixture, and the mixture is aseptically thermally processed, at least partially cooled, and then aseptically homogenized.

The presently disclosed and/or claimed inventive concept(s) is also directed to a method of producing a smooth, shelf-stable food product, in which at least one food component and at least one shear sensitive thickener are mixed to form a mixture, and the mixture is aseptically thermally processed, at least partially cooled, and then aseptically homogenized. The aseptically homogenized, at least partially cooled, thermally processed mixture is then aseptically packaged in one or more packages.

The presently disclosed and/or claimed inventive concept(s) is also directed to a smooth, shelf-stable food product, comprising at least one food component (as described above) and at least one shear sensitive thickener (as described above). The smooth, shelf-stable food product may be produced by any of the methods described herein above or by any other method known in the art. In one embodiment, the food product is shelf-stable at room temperature.

In one embodiment, the presently disclosed and/or claimed inventive concept(s) is directed to a smooth, shelf-stable food product comprising a dairy product and at least one shear sensitive thickener. The dairy product may be, for example but without limitation, yogurt, pudding, sour cream, buttermilk, and/or any spoonable milk-based product.

The food product as described in the above-embodiments may also have/be at least one of (i) a “high protein content,” wherein the protein content is about 2 wt % or greater of the food component and/or the food product; (ii) fortified with at least one vitamin and/or mineral; and/or (iii) have an additive therein.

The fortified food component may be fortified such that the food component comprises more than 5% daily value equivalent of the at least one vitamin and/or mineral, or more than 10% daily value equivalent of the at least one vitamin and/or mineral. The vitamin may include, for example but without limitation, Vitamins A, B-complex (such as B-1, B-2, B-6, and B-12), C, D, E, and K, niacin, acid vitamins such as pantothenic acid and folic acid, and biotin. The mineral may include, for example but without limitation, calcium, iron, zinc, magnesium, iodine, copper, phosphorus, manganese, potassium, chromium, molybdenum, selenium, nickel, tin, silicon, vanadium, and boron.

The one or more additives may include, for example but without limitation, sweeteners, flavors, colors, acids, acidity regulators, anticaking agents, antifoaming agents, antioxidants, bulking agents, color retention agents, emulsifiers, flavor enhancers, flour treatment agents, glazing agents, humectants, preservatives, stabilizers, thickeners, and/or combinations thereof.

The combinations of any of the method steps described herein above may be performed simultaneously or wholly or partially sequentially. In addition, the exemplary sequences of method steps provided herein above are for the purposes of illustration only; it will be understood that the individual steps, as well as the particular order of steps, may vary, and the sequence of steps may be performed in any order, so long as the food component(s), additive(s), and shear sensitive thickener(s) described herein are capable of functioning in accordance with the presently disclosed and/or claimed inventive concept(s).

Thus, in accordance with the presently disclosed and/or claimed inventive concept(s), there has been provided a smooth, shelf-stable food product comprising at least one food component and at least one shear sensitive thickener, as well as methods of producing and using same, that fully satisfy the objectives and advantages set forth herein above. Although the presently disclosed and/or claimed inventive concept(s) has been described in conjunction with the specific language set forth herein above, it is evident that many alternatives, modifications, and variations will be apparent to those skilled in the art. Accordingly, it is intended to embrace all such alternatives, modifications, and variations that fall within the spirit and broad scope of the presently disclosed and/or claimed inventive concept(s). Changes may be made in the construction and the operation of the various components, elements, and assemblies described herein, as well as in the steps or the sequence of steps of the methods described herein, without departing from the spirit and scope of the presently disclosed and/or claimed inventive concept(s).

1. A method of producing a smooth, shelf-stable food product, comprising:
aseptically homogenizing a mixture comprising at least one food component and at least one shear sensitive thickener, wherein the at least one food component has a protein content of 2 wt % or greater.

2. The method of claim 1, wherein the at least one food component is selected from the group consisting of dairy products, meat products, vegetable products, and combinations thereof.

3. The method of claim 1, wherein the at least one food component is a dairy product selected from the group consisting of pudding, yogurt, sour cream, buttermilk, and combinations thereof.

4. The method of claim 1, wherein the at least one food component is at least one of a meat puree and a vegetable puree.

5. The method of claim 1, wherein the at least one food component is baby food.

6. The method of claim 1, wherein the at least one food component has been fortified with at least one of a vitamin and a mineral.

7. The method of claim 1, wherein the at least one shear sensitive thickener comprises citrus fiber.

8. The method of claim 1, wherein the mixture further comprises additives selected from the group consisting of sweeteners, flavors, colors, acids, acidity regulators, anticaking agents, antifoaming agents, antioxidants, bulking agents, color retention agents, emulsifiers, flavor enhancers, flour treatment agents, glazing agents, humectants, preservatives, stabilizers, thickeners, and combinations thereof.

9. The method of claim 1, wherein the mixture is aseptically thermally processed prior to aseptically homogenizing the mixture, wherein the step of aseptically thermally processing the mixture comprises heating the mixture at a temperature in a range of from about 175° F. to about 325° F.

10. The method of claim 1, wherein the mixture is aseptically thermally processed after aseptically homogenizing the mixture, wherein the step of aseptically thermally processing the mixture comprises heating the mixture at a temperature in a range of from about 175° F. to about 325° F.

11. The method of claim 1, wherein the step of aseptically thermally processing the mixture uses at least one of a direct heating method and an indirect heating method.

12. The method of claim 9, wherein the mixture is at least partially cooled after the step of aseptically thermally processing the mixture and prior to the step of aseptically homogenizing the mixture, wherein the mixture is at least partially cooled to a temperature in a range of from about 120° F. to about 160 ° F.

13. The method of claim 9, wherein the mixture is at least partially cooled to a temperature such that fats in the at least one food component are still in liquid form.

14. The method of claim 9, wherein the step of at least partially cooling the mixture uses at least one of a direct cooling method and an indirect cooling method.

15. The method of claim 1, wherein the mixture is aseptically packaged into one or more packages after the step of aseptically homogenizing the mixture.

16. A food product comprising:
at least one shear sensitive thickener; and
at least one food component selected from the group consisting of dairy products, meat products, vegetable products, and combinations thereof, produced by any one of the methods of claims 1 to 15.

17. The food product of claim 16, wherein the food product is smoother as compared to food products produced by an alternative method.

18. The food product of claim 16, wherein the food product is shelf-stable.

19. The food product of claim 16, wherein the food product is a smooth, shelf-stable dairy product.

20. The food product of claim 16, wherein the food product is baby food.
